(19) United States
(12) Patent Application Publication
(10) Pub. No.: US 2009/0304192 A1
(43) Pub. Date: Dec. 10, 2009

(54) METHOD AND SYSTEM FOR PHASE DIFFERENCE MEASUREMENT FOR MICROPHONES

(75) Inventors: Zhanping ZHUANG, Nangjing (CN); Bo ZHANG, Nangjing (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 12/133,493

(22) Filed: Jun. 5, 2008

(51) Int. Cl. H04R 29/00

(52) U.S. Cl. 381/58

(57) ABSTRACT

The invention provides a system for phase difference measurement. In one embodiment, the system comprises a speaker, a high-speed digital input/output (HSDIO) device, and a testing computer. The speaker plays a test voice, wherein a reference microphone converts the test voice to a reference signal, and a plurality of test microphones convert the test voice to a plurality of tested signals. The HSDIO device receives the reference signal and the tested signals, and generates a multi-bit datastream according to the reference signal and the tested signals, wherein each word of the multi-bit datastream comprises a bit of the reference signal and a plurality of bits of the tested signals. The testing computer retrieves the reference signal and the tested signals from the multi-bit datastream, and measures phase differences between the tested signals and the reference signal.

### BACKGROUND OF THE INVENTION

1. Field of the Invention

The invention relates to microphones, and more particularly to phase difference measurement for microphones.

2. Description of the Related Art

An array microphone is a microphone module comprising a plurality of component microphones. When an array microphone receives a sound, the component microphones of the array microphone convert the sound to a plurality of output signals. Although the output signals are derived from the same sound source, the output signals have slight differences therebetween due to difference between the reception locations of the component microphones, and a processor can derive significant spacial information for signal processing from the differences between the output signals.

In addition to the location difference, differences between intrinsic properties of the component microphones, however, also result in phase differences between the output signals generated by the component microphones. To avoid spacial information calculation errors, the phase differences due to property differences between the component microphones of an array microphone must therefore be measured and calibrated in advance. In addition, phase differences between component microphones of an array microphone are often required to be lower than a threshold. To determine the phase differences of component microphones of array microphones, a system capable of phase difference measurement is therefore required.

Referring to FIG. 1, a block diagram of a conventional system 100 for phase difference measurement is shown. In the system 100, two microphones 102 and 104 are coupled to the testing computer 106. In one embodiment, the microphone 104 is a test microphone, and the microphone 102 is a reference microphone as a comparison reference for the test microphone. Each of the microphones 102 and 104 has a chip select pin CS, a clock pin CLK, a data pin DATA, a voltage source pin VCC, and a ground pin GND. The clock pins of both the microphones 102 and 104 are coupled together to receive a clock signal provided by the testing computer 106. A chip select pin of the microphone 102 is coupled to a ground voltage source GND, and a chip select pin of the microphone 104 is coupled to a high voltage source VCC. The data pins of both the microphones 102 and 104 are both coupled to a data input path of the testing computer.

When a sound is played, both the microphones 102 and 104 convert the sound into electric signals and output the electric signals via the data pins DATA. In one embodiment, the microphones 102 and 104 output the signals with a pulse density modulation (PDM) format. Referring to FIG. 2, a schematic diagram of signals transmitted between the microphones 102 and 104 and the testing computer 106 of FIG. 1 is shown. When a chip select pin of a microphone is coupled to a ground voltage, the microphone is set to an L mode and outputs data according to triggers of falling edges of a clock signal. When a chip select pin of a microphone is coupled to a high voltage voltage, the microphone is set to an R mode and outputs data according to triggers of rising edges of a clock signal. The microphone 102 therefore outputs data 212, 214, and 216 according to falling edges of the clock signal provided by the testing computer 106, and the microphone 104 outputs data 222, 224, and 226 according to rising edges of the clock signal provided by the testing computer 106. Thus, the testing computer 106 receives a data signal comprising both data 212, 214, and 216 generated by the microphone 102 and data 222, 224, and 226 generated by the microphone 104 with a single data path.

Because the signals generated by the microphones 102 and 104 have a PDM format, the data received by the testing computer 106 also has a PDM format. In one embodiment, the testing computer 106 further comprises a coder-decoder (CODEC) 108 converting the received data from a PDM format to a pulse code modulation (PCM) format. The testing computer 106 then recovers signals generated by the microphones 102 and 104 according to received data, and measures phase difference between the signals. Thus, the phase difference between the signals generated by the microphones 102 and 104 is measured.

The conventional system 100, however, measures phase difference between only one test microphone and a reference microphone at a time. When phase difference of more than one test microphone are to be measured, a user of the conventional system 100 must repeatedly replace an old test microphone with a new test microphone for phase difference measurement and perform the same testing process again and again, wasting the user's time. In addition, the signals received by the testing computer 106 are not synchronous. Referring to FIG. 2, because the sampling times of the data 212, 214, and 216 differ from the sampling times of the data 222, 224, and 226 by half a clock cycle, the signals received by the testing computer 106 has intrinsic phase difference of half a clock cycle. The difference of sampling time of the microphones 102 and 104 therefore cause difficulty in measuring actual phase difference between the microphones 102 and 104. Thus, a system capable of phase difference measurement without the aforementioned shortcomings is therefore required.

### BRIEF SUMMARY OF THE INVENTION

The invention provides a system for phase difference measurement. In one embodiment, the system comprises a speaker, a high-speed digital input/output (HSDIO) device, and a testing computer. The speaker plays a test voice, wherein a reference microphone converts the test voice to a reference signal, and a plurality of test microphones convert the test voice to a plurality of tested signals. The HSDIO device receives the reference signal and the tested signals, and generates a multi-bit datastream according to the reference signal and the tested signals, wherein each word of the multi-bit datastream comprises a bit of the reference signal and a plurality of bits of the tested signals. The testing computer retrieves the reference signal and the tested signals from the multi-bit datastream, and measures phase differences between the tested signals and the reference signal.

The invention also provides a method for phase difference measurement for microphones. First, a test voice is played with a speaker. The test voice is then converted to a reference signal by a reference microphone. The test voice is also converted to a plurality of tested signals by a plurality of test microphones. A multi-bit datastream is then generated according to the reference signal and the tested signals with a high-speed digital input/output (HSDIO) device, wherein each word of the multi-bit datastream comprises a bit of the reference signal and a plurality of bits of the tested signals. The reference signal and the tested signals are then retrieved from the multi-bit datastream with a testing computer. Phase differences between the tested signals and the reference signal are then measured with the testing computer.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a conventional system for phase difference measurement;

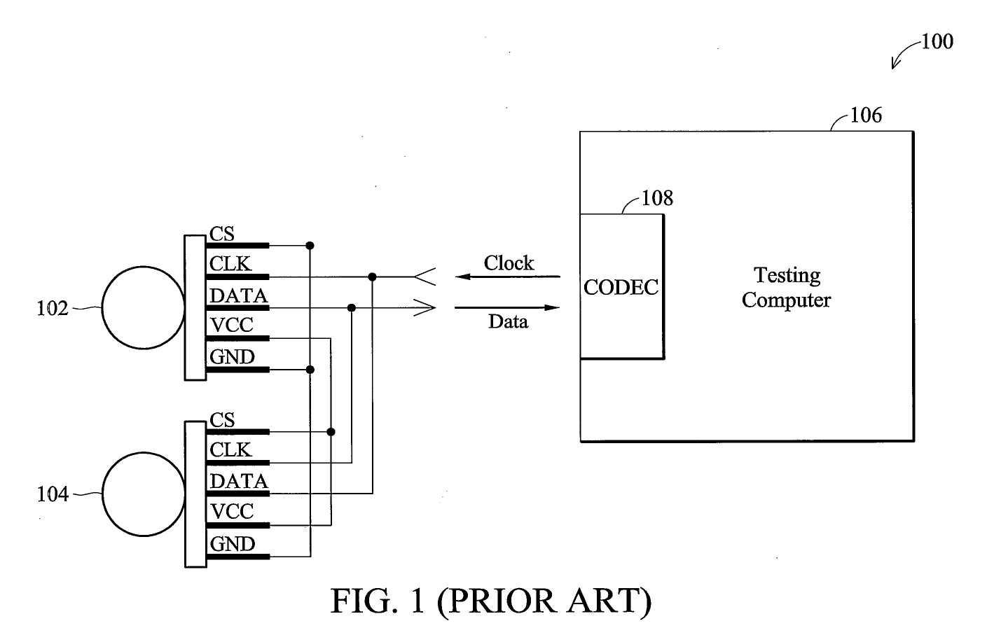

FIG. 2 is a schematic diagram of signals transmitted between microphones and a testing computer of FIG. 1;

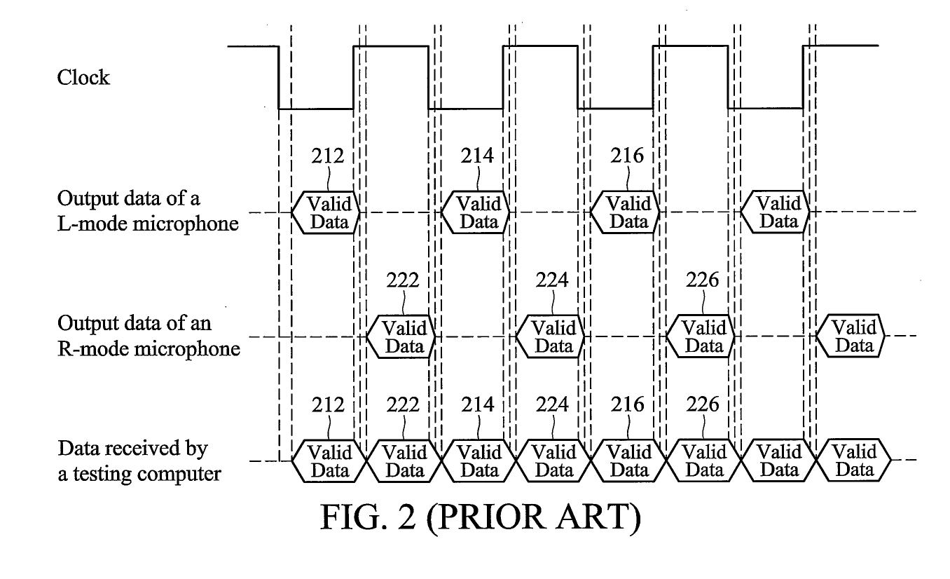

FIG. 3 is a block diagram of a system for phase difference measurement for microphones according to the invention;

FIG. 4 is a schematic diagram of signals generated by the microphones of FIG. 3 according to the invention;

FIG. 5 is a block diagram of a sync filter according to the invention; and

FIG. 6 is a schematic diagram of measurement of phase difference between a reference signal and a tested signal.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

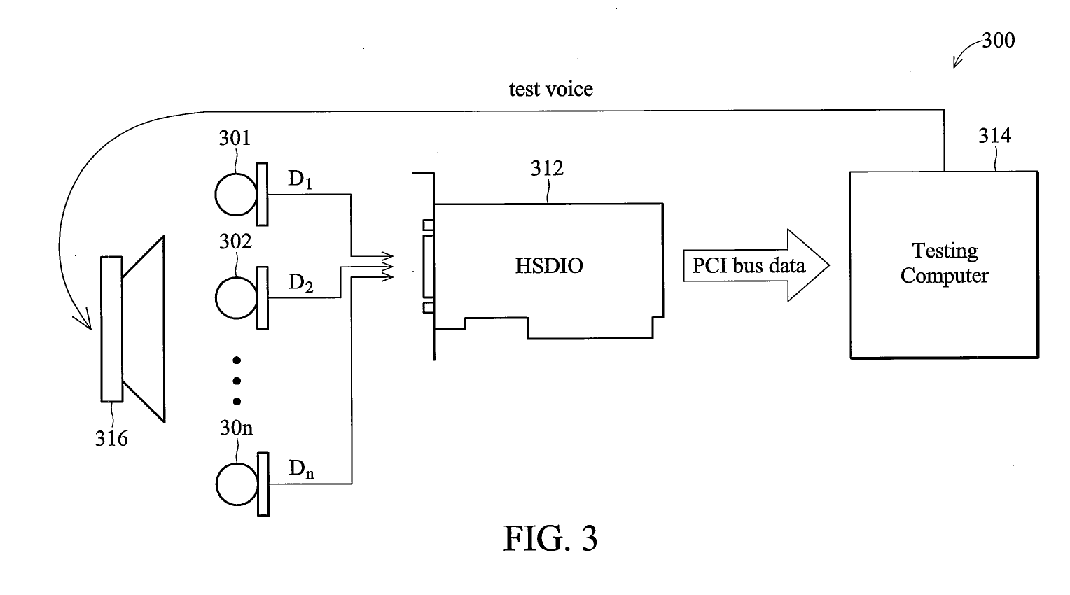

Referring to FIG. 3, a block diagram of a system 300 for phase difference measurement for microphones according to the invention is shown. The system 300 comprises a speaker 316, a high speed digital input/output (HSDIO) device 312, and a testing computer 314. Data pins of a plurality of microphones 301˜30n are respectively connected to the HSDIO device 312. One of the microphones 301˜30n is a reference microphone for phase comparison reference, and the other microphones are test microphones. In one embodiment, the HSDIO device 312 has an input interface comprising a plurality of input pins, and each of the data pins of the microphones 301˜30n is coupled to one of input pins of the HSDIO device 312. The HSDIO device 312 is coupled to the testing computer 314. Thus, when the microphones 301˜30n generates signals D₁˜Dₙ, the HSDIO device 312 simultaneously delivers the signals D₁˜Dₙ to the testing computer 314. In one embodiment, the HSDIO device 312 is coupled to the testing computer 314 via a peripheral component interconnect (PCI) bus. The testing computer 314 is further connected to the speaker 316.

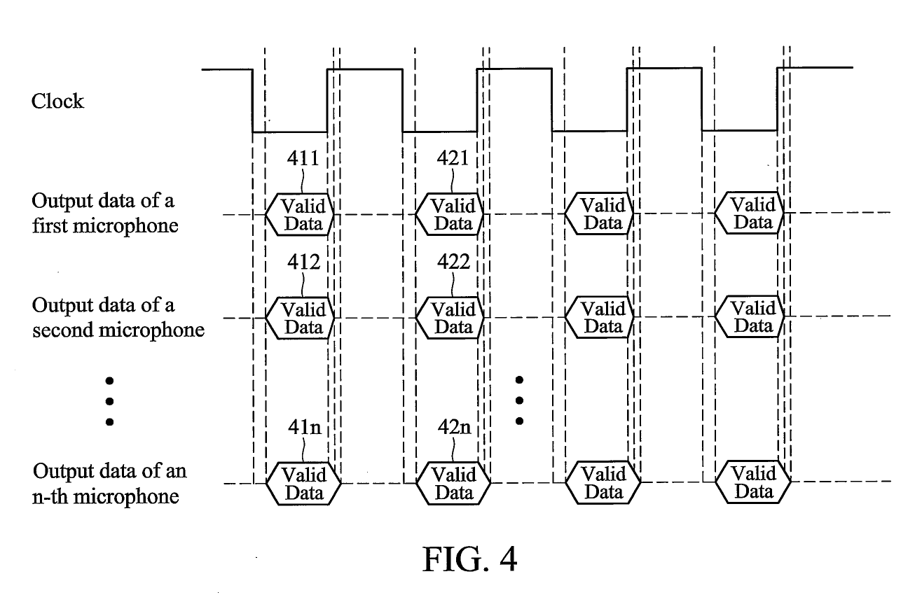

When a testing process is initiated, the testing computer 314 sends a test voice to the speaker 316, and the speaker 316 plays the test voice. The speaker 316 is placed at a location with almost equal distances from the microphones 301˜30n. The microphones 301˜30n then respectively convert the test voice to a plurality of electric signals D₁˜Dₙ. In one embodiment, the electric signals D₁˜Dₙ have a pulse density modulation (PDM) format. The HSDIO device 312 provides the microphones 301˜30n with a clock signal, and the microphones 301˜30n generates the signals D₁˜Dₙ according to the clock signal. The microphones 301˜30n can be set to one of an L mode or an R mode. In the L mode, all of the microphones 301˜30n generate data samples of the signals D₁˜Dₙ when the clock signal falls from a logic high level to a logic low level. In the R mode, all of the microphones 301˜30n generate data samples of the signals D₁˜Dₙ when the clock signal rises from a logic low level to a logic high level. The data samples of the output signals D₁˜Dₙ of the microphones 301˜30n are therefore synchronously generated without delay therebetween. Referring to FIG. 4, a schematic diagram of signals D₁˜Dₙ generated by the microphones 301˜30n of FIG. 3 according to the invention is shown. The microphones 301˜30n are set to the L mode and generate data samples according to triggers of falling edges of the clock signal.

It is assumed that the input interface of the HSDIO device 312 has M input pins, and a number of the microphones 301˜30n is n, wherein M and n are natural numbers, and n is less than or equal to M. Because each of the microphones 301˜30n generates one data sample during one clock cycle, the microphones 301˜30n generates n bits of data in total during one clock cycle. The HSDIO device 312 then collects the samples generated by the microphones 301˜30n during the same clock cycle to form a word, wherein the word contains M bits, and N bits of the word are significant. For example, the HSDIO device 312 generates a first word comprising the data samples 411, 412, . . . , 41n output during a first clock cycle, and generates a second word comprising the data samples 421, 422, . . . , 42n output during a second clock cycle. When the microphones 301˜30n generate a plurality of bit series D₁˜Dₙ, the HSDIO device 312 generate a multi-bit datastream comprising a series of words derived from the bit series D₁˜Dₙ. The HSDIO device 312 then delivers the multi-bit datastream to the testing computer 314 via the PCI bus.

After the testing computer 314 receives the multi-bit datastream, the testing computer 314 then retrieves the signals D₁˜Dₙ generated by the microphones 301˜30n from the multi-bit datastream. In one embodiment, because each bit of a word of the multi-bit datastream represents a data bit of one of the signals D₁˜Dₙ, the testing computer 314 multiplies the multi-bit datastream by a plurality of bit masks to obtain the signals D₁˜Dₙ, wherein each of the bit masks comprises (M-1) bits of zeros except for one bit corresponding to the retrieved signal.

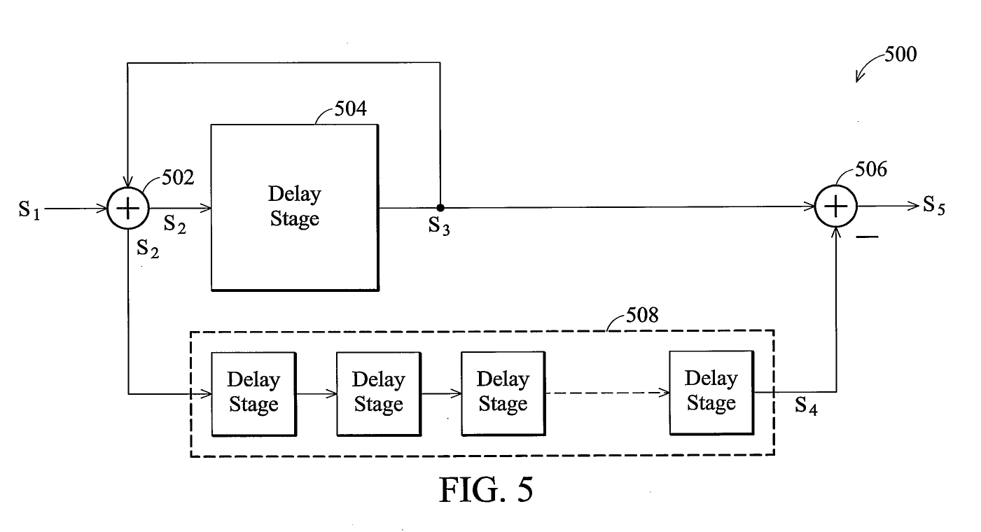

After the signals D₁˜Dₙ are obtained, the testing computer measures phase differences between the signals D₁˜Dₙ. Before the phase differences are measured, the testing computer 314 converts the signals D₁˜Dₙ from the PDM format to a pulse code modulation (PCM) format. In one embodiment, the testing computer 314 comprises a format conversion module for format conversion from PDM to PCM, wherein the format conversion module is a hardware circuit or a firmware program. The format conversion module comprises a plurality of sync filters connected in series and a down sampler. Referring to FIG. 5, a block diagram of a sync filter 500 according to the invention is shown. The sync filter 500 comprises an adder 502, a delay stage 504, a subtractor 506, and a delay line 508. The adder 502 adds a delayed signal S₃ to an input signal S₁ to obtain a signal S₂. The delay stage 504 then delays the signal S₂ for a clock cycle to obtain the delayed signal S₃. In addition, the delay line 508 comprising a plurality of delay stages delays the signal S₂ for a long period to obtain a delayed signal S₄. The subtractor 506 then subtracts the delayed signal S₄ from the delayed signal S₃ to obtain an output signal S₅. After processing of the sync filters and the down sampler, the signals D₁˜Dₙ are converted from the PDM format to the PCM format.

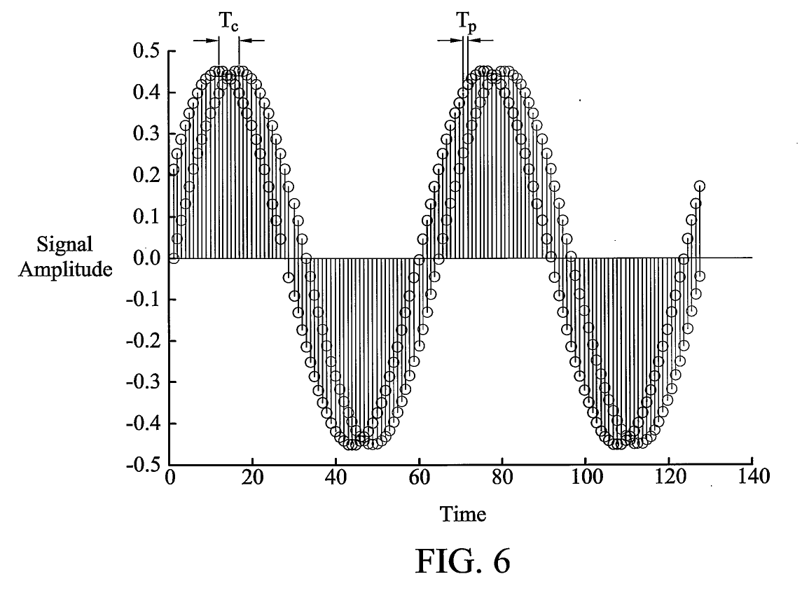

Finally, the testing computer 314 measures phase difference between the signals D₁˜Dₙ generated by the microphones 301˜30n. Because the microphones 301˜30n converts the same test voice to the signals D₁˜Dₙ, the wave shapes of the signals D₁˜Dₙ are almost the same. Thus, comparison of delay difference between the signals D₁˜Dₙ is easy. One of the signals D₁˜Dₙ is a reference signal generated by the reference microphones, and the other signals are tested signals generated by the test microphones. The testing computer 314 then respectively determines a delay period between the reference signal and one of the tested signals. Referring to FIG. 6, a schematic diagram of measurement of phase difference between a reference signal and a tested signal is shown. The reference signal and the tested signal are sine waves with a delay period T_{c} therebetween. The testing computer 316 first determines the delay period T_{c} between the reference signal and the tested signal, and then divides the delay period T_{c} by a sampling period Tₚ to obtain the phase difference between the reference signal and the tested signal.

Because the distances between the speaker 316 and the microphones 301˜30n are almost equal, the test voice played by the speaker 316 propagates to the microphones 301˜30n with the same delay, and the delay period T_{c} between the reference signal and the tested signal is induced by the circuit property difference between the test microphone and the reference microphone. Thus, the measured phase difference between the tested signal and the reference signal is caused the by circuit property difference between the test microphone and the reference microphone. After a phase difference corresponding to all test microphones are measured, the testing computer 314 compares the phase differences with a predetermined threshold to determine whether the test microphones are qualified. If a test microphone has a measured phase difference greater than the threshold, the test microphone is abandoned. Thus, an array microphone fabricated with the qualified microphones is ensured of generating output signals with little phase differences due to circuit properties, and spatial information with correctness can be derived from the output signals of the array microphone.

The invention provides a system 300 capable of phase difference measurement. Because the HSDIO device 312 transmits synchronous data samples of the output signals D₁˜Dₙ of the microphones 301˜30n to the testing computer 314, there is no signal sampling delay between a reference signal generated by a reference microphone and a tested signal generated by a test microphone, and a precise phase difference between the reference signal and the tested signal is measured. In addition, the system 300 measures phase differences of output signals of a plurality of test microphones at one time, reducing user effort. Thus, the system 300 provided by the invention is more convenient for the user than the conventional system 100.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for phase difference measurement for microphones, comprising:
a speaker, playing a test voice, wherein a reference microphone converts the test voice to a reference signal, and a plurality of test microphones convert the test voice to a plurality of tested signals;
a high-speed digital input/output (HSDIO) device, coupled to the reference microphone and the test microphones, receiving the reference signal and the tested signals, and generating a multi-bit datastream according to the reference signal and the tested signals, wherein each word of the multi-bit datastream comprises a bit of the reference signal and a plurality of bits of the tested signals; and
a testing computer, coupled to the HSDIO device, retrieving the reference signal and the tested signals from the multi-bit datastream, and measuring phase differences between the tested signals and the reference signal.

2. The system as claimed in claim 1, wherein the testing computer respectively multiplies words of the multi-bit datastream by a plurality of bit masks to obtain the reference signal and the tested signals.

3. The system as claimed in claim 1, wherein the testing computer measures a plurality of delayed periods between the tested signals and the reference signal, and then divides the delayed periods by a sampling period to obtain the phase differences.

4. The system as claimed in claim 1, wherein the testing computer compares the phase differences with a predetermined threshold to determine whether the test microphones are qualified.

5. The system as claimed in claim 1, wherein the HSDIO device provides the reference microphone and the test microphones with a clock signal, and the reference microphone and the test microphones generate the reference signal and the tested signals according to the clock signal.

6. The system as claimed in claim 5, wherein the reference microphone and the test microphones generate samples of the reference signal and the tested signals when the clock signal falls from a logic high level to a logic low level.

7. The system as claimed in claim 5, wherein the reference microphone and the test microphones generate samples of the reference signal and the tested signals when the clock signal rises from a logic low level to a logic high level.

8. The system as claimed in claim 1, wherein the reference microphone and the test microphones generate the reference signal and the tested signals with a pulse density modulation (PDM) format.

9. The system as claimed in claim 8, wherein the testing computer comprises a format conversion module, converting the reference signals and the tested signals from the PDM format to a pulse code modulation (PCM) format before the phase differences therebetween are measured.

10. The system as claimed in claim 9, wherein the format conversion module comprises at least one sync filter, comprising:
an adder, adding a first delayed signal to an input signal to obtain a second signal;
a delay stage, delaying the second signal to obtain the first delayed signal;
a delay line, comprising a plurality of delay stages, delaying the second signal for a long period to obtain a second delay signal; and
a subtractor, subtracting the second delay signal from the first delayed signal to obtain an output signal.

11. The system as claimed in claim 1, wherein the HSDIO device transmits the multi-bit datastream to the testing computer via a peripheral component interconnect (PCI) bus.

12. A method for phase difference measurement for microphones, comprising:
playing a test voice with a speaker;
converting the test voice to a reference signal with a reference microphone;
converting the test voice to a plurality of tested signals with a plurality of test microphones;
generating a multi-bit datastream according to the reference signal and the tested signals with a high-speed digital input/output (HSDIO) device, wherein each word of the multi-bit datastream comprises a bit of the reference signal and a plurality of bits of the tested signals;
retrieving the reference signal and the tested signals from the multi-bit datastream with a testing computer; and
measuring phase differences between the tested signals and the reference signal with the testing computer.

13. The method as claimed in claim 12, wherein retrieving of the reference signal and the tested signals comprises respectively multiplying the multi-bit datastream by a plurality of bit masks to obtain the reference signal and the tested signals.

14. The method as claimed in claim 12, wherein measurement of the phase differences comprises:
measuring a plurality of delayed periods between the tested signals and the reference signal; and
dividing the delayed periods by a sampling period to obtain the phase differences.

15. The method as claimed in claim 12, wherein the method further comprises comparing the phase differences with a predetermined threshold to determine whether the test microphones are qualified.

16. The method as claimed in claim 12, wherein the HSDIO device provides the reference microphone and the test microphones with a clock signal, and the reference microphone and the test microphones generate the reference signal and the tested signals according to the clock signal.

17. The method as claimed in claim 16, wherein the reference microphone and the test microphones generate samples of the reference signal and the tested signals when the clock signal falls from a logic high level to a logic low level.

18. The method as claimed in claim 16, wherein the reference microphone and the test microphones generate samples of the reference signal and the tested signals when the clock signal rises from a logic low level to a logic high level.

19. The method as claimed in claim 12, wherein the reference signal and the tested signals generated by the reference microphone and the test microphone have a pulse density modulation (PDM) format.

20. The method as claimed in claim 19, wherein the method further comprises converting the reference signals and the tested signals from the PDM format to a pulse code modulation (PCM) format with the testing computer before the phase differences therebetween are measured.

21. The method as claimed in claim 12, wherein the multi-bit datastream is transmitted from the HSDIO device to the testing computer via a peripheral component interconnect (PCI) bus.
